(19) United States
(12) Patent Application Publication
(10) Pub. No.: US 2025/0367733 A1
(43) Pub. Date: Dec. 4, 2025

(54) INTERCHANGEABLE CONTAINER AND DEVICE FOR PRODUCING A THREE-DIMENSIONAL COMPONENT

(71) Applicant: ONE CLICK METAL GMBH, Tamm (DE)

(72) Inventor: Michael Volk, Ludwigsburg (DE)

(21) Appl. No.: 18/872,820

(22) PCT Filed: May 23, 2023
(86) PCT No.: PCT/EP2023/063824

§ 371 Date: Dec. 7, 2024

(30) Foreign Application Priority Data
Jun. 7, 2022 (DE) 10 2022 114 262.0

(51) Int. Cl. B22F 12/80; B22F 12/00; B22F 12/30; B22F 12/50; B22F 12/70; B33Y 30/00

(52) U.S. Cl. CPC B22F 12/80; B22F 12/30; B22F 12/38; B22F 12/50; B22F 12/70; B33Y 30/00

(57) ABSTRACT

The invention relates to an interchangeable container and to a device for producing a three-dimensional component (12) by selective solidification of a build-up material (13), applied in layers, by means of a beam (25) acting on the build-up material (13), comprising a peripheral wall (81) and a connection interface (91), formed at the upper edge of the peripheral wall (81), for connecting to a base (21) of the process chamber (16), characterized in that, within the peripheral wall (81), the interchangeable container (22) comprises: a storage means (51) having a piston (53) for dispensing powdered build-up material (13), which piston is controllable by a piston drive (55), a build chamber (61) having a build platform (17) for layered building of the component (12), which is driveable by a build chamber drive (54), and a work surface (82) which is provided on an upper end of the peripheral wall (81), which has an opening (52, 62, 19) for the storage means (51), the build chamber (61) and the collection device (71). (See FIG. 3)

The invention relates to an interchangeable container for a process chamber of a device for producing a three-dimensional component by selective solidification of a build-up material applied in layers by means of a beam acting on the build-up material, and to such a device for producing the three-dimensional component.

DE 10 2017 124 424 A1 discloses a device for manufacturing three-dimensional components. This device comprises a process chamber which has at least one working surface aligned in an X/Y plane, to which a construction cylinder is interchangeably assigned. In this construction cylinder, a substrate plate is movably controlled by a drive. The three-dimensional component is produced on this substrate plate. This device comprises a lifting device below the base of the process chamber, by means of which the construction cylinder can be moved downwards relative to the base of the process chamber in order to subsequently replace the exchangeable container containing the component with a fresh exchangeable container.

DE 10 2017 208 651 A1 discloses a manufacturing module for the additive manufacturing of components. This production module comprises a storage container for a base material as well as a build platform for the additive construction of the component and a surplus container for build-up material not solidified during additive production. Such a production module is moved into a production station. The production module is then raised hydraulically to a working position and leveled, for example by laser interferometry.

Due to the increasing spread of additive manufacturing processes in industry and their use in ever new sectors, the demand for different available materials is growing at the same time. This often requires a change of material without cross-contamination and the processing of small quantities of powder.

According to WO 2016/055523 A1, an insert comprising a storage container, a construction chamber and a collecting device is proposed to reduce the installation space for processing small quantities of powder. This insert can be inserted into a construction chamber attached to the base of the process chamber. To actuate this insert, it is necessary to connect the substrate plate of the construction chamber to a lifting drive of the insert and to actuate the insert, it is necessary to actuate the substrate plate in the construction chamber. The installation of this insert is very complex. In addition, this insert is placed on the edge of the construction chamber on the floor of the process chamber. Cross-contamination can occur when changing the insert.

The invention is based on the task of proposing an interchangeable container for a process chamber of a device for producing a three-dimensional component and such a device, by which a reduction in installation space as well as a reduction in cross-contamination is made possible.

This task is solved by an interchangeable container which, within its peripheral wall, comprises a storage device with a piston for dispensing the powdery build-up material, which can be actuated by a piston drive, as well as a build chamber with a substrate plate for the layer-by-layer build-up of the component, which can be driven by a build chamber drive, and a build-up platform provided at the upper end of the peripheral wall, which has an opening each for the storage device, the build chamber and the collecting device. This interchangeable container has the advantage that it is interchangeable with an interchangeable container in which only one substrate plate can be moved up and down to build up the component layer by layer. The size of the interchangeable container, in which only the substrate plate can be moved up and down, remains with the interchangeable container according to the invention, whereby the storage device and the construction chamber are arranged in the interchangeable container according to the invention. This makes it possible to reduce the installation space, in particular in the construction chamber. Thus, the amount of construction material required in the construction chamber for the production of components with a small construction volume can be considerably reduced.

Preferably, in addition to the storage device and the construction chamber, the interchangeable container comprises a collecting device, in particular with a collecting container, for collecting unconsolidated construction material. Advantageously, the storage device is positioned adjacent or contiguous to the construction chamber. The collecting device is arranged opposite the storage device and adjacent or adjacent to the construction chamber. This enables an efficient and economical material change without cross-contamination, since the storage device and the collecting device are simultaneously removed from the process chamber when the interchangeable container according to the invention is changed.

Preferably, a closed base is provided at the lower end of the peripheral wall of the interchangeable container. In this way, the interchangeable container can form a closed unit in which only the working surface with the necessary openings for the storage device, the construction chamber and the collecting device are provided at the upper end. This increases the reduction of contamination.

At least one fastening element can be provided on the outer circumference of the peripheral wall of the interchangeable container, which can be connected to the process chamber with a complementary fastening element of the fastening device. This enables quick and easy replacement. Preferably, the fastening device can be operated without tools.

Furthermore, it is preferable that a plug-in connection is provided on the circumferential wall, at least for the electrical supply of the piston drive and the construction chamber drive. Such a plug-in connection can enable rapid commissioning of the new interchangeable container after a change.

At the upper end of the interchangeable container, in particular adjacent to the working surface of the interchangeable container, a connection interface is advantageously designed as a stepped shoulder with a circumferential seal. This allows the interchangeable container to be positioned flush with the working surface of the bottom of the process chamber. At the same time, a sealing arrangement can be created so that selective solidification of the powdery build-up material can take place in an inert gas atmosphere within the process chamber.

Furthermore, the stepped shoulder on the upper edge of the interchangeable container is preferably provided in such a way that the interchangeable container can be connected to the bottom of the process chamber from below.

The piston drive for dispensing the build-up material from the storage device and the build chamber drive for controlling a lifting movement of the substrate plate in the build chamber can preferably be controlled separately from each other. For example, a motor is provided for each drive. The control can be synchronized by a control device. However, the two drives are preferably physically separate from each other and in particular are not connected to each other.

Advantageously, a spindle drive is provided between the piston drive and the piston of the storage device and between the build chamber drive and the build platform of the build chamber. This enables a small installation space in terms of height as well as precise control during an actuating movement, so that even very thin layers of build-up material can be attached.

Furthermore, it is preferable that the length of the opening of the collecting device is greater than the length of the opening of the storage container and the construction chamber in the working surface at the upper end of the exchangeable container. This enables the largest possible proportion of unconsolidated build-up material to be transferred to the collecting device by the leveling device during the production of the three-dimensional component.

The circumferential wall of the interchangeable container preferably has a square or rectangular cross-section, with rounded corners in particular. This enables a compact design.

The task underlying the invention is further solved by an apparatus for producing a three-dimensional component by selective solidification of a build-up material applied in layers by means of a beam acting on the build-up material, in which an interchangeable container according to one of the above embodiments can be used in an opening in the base of the process chamber to reduce the installation space. As a result, the interchangeable container according to one of the previous embodiments can now be used instead of a previous interchangeable container with a superstructure platform, the cross-section of which formed the installation space volume. The size of the interchangeable container, particularly in the connection area for positioning in the opening in the base of the process chamber, is preferably the same for both the interchangeable container according to the invention and the interchangeable container that only accommodates a mounting platform. This also makes it possible to reduce the installation space of an existing device and to reduce cross-contamination during a material change.

Preferably, a fastening element of a fastening device is provided in association with the process chamber, which can be connected to the fastening element provided on the exchangeable container. This allows the entire interchangeable container, including the storage device of the construction chamber and the collecting device, to be replaced quickly.

Advantageously, the fastening device is designed as a quick clamping device. For example, a lever clamping device or rotary clamping device or rotary clamping device or the like can be provided. Screw connections with a star grip can also be used.

In particular, the fastening device is designed to be tool-free. This facilitates handling when changing the interchangeable containers.

Furthermore, it is preferable that in a first fastening step, the interchangeable container can be positioned hanging loosely on the fastening element provided on the process chamber and aligned with the opening in the base of the process chamber and then, in a second fastening step, the connection point of the interchangeable container can be braced with the opening in the base. This makes it possible to securely mount the interchangeable container to the base of the process chamber, since in the first step the interchangeable container is aligned with the opening before they can be clamped together to form a sealed arrangement.

The invention and other advantageous embodiments and further embodiments thereof are described and explained in more detail below with reference to the examples shown in the drawings. The features to be taken from the description and the drawings can be used individually or in any combination in accordance with the invention. It shows:

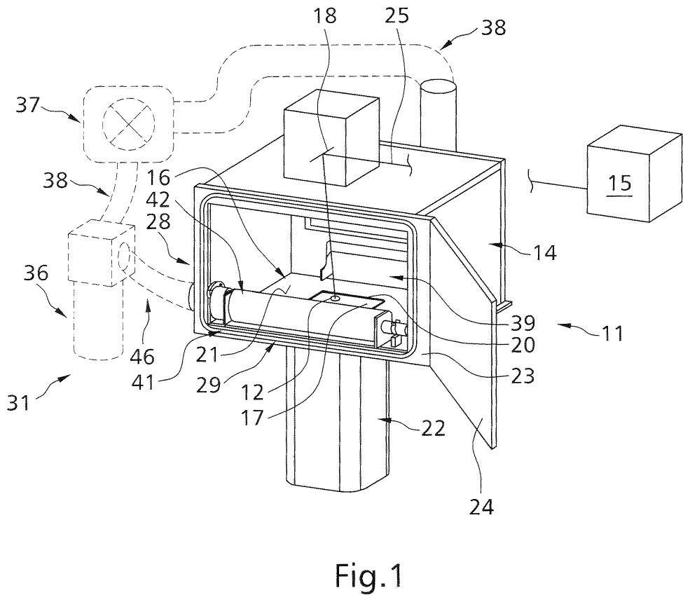

FIG. 1 a perspective view of a device for producing a three-dimensional component,

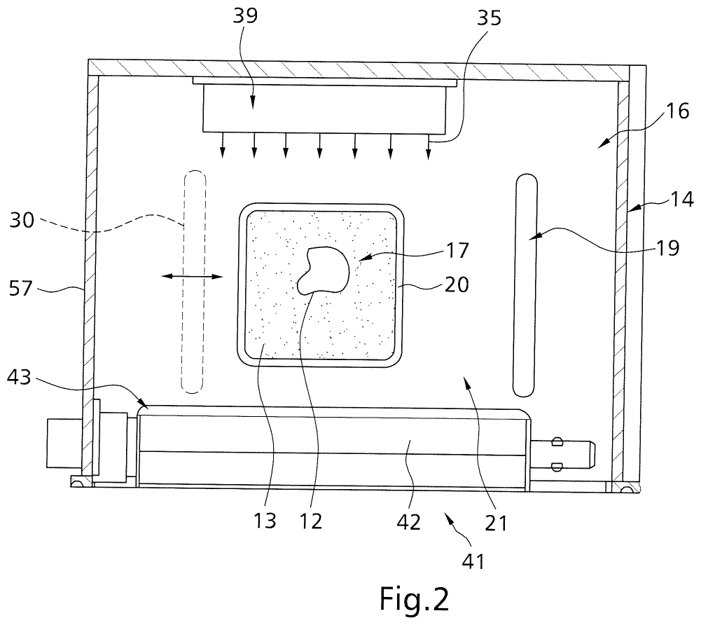

FIG. 2 a schematic view from above of a bottom of the process chamber according to the device in FIG. 1,

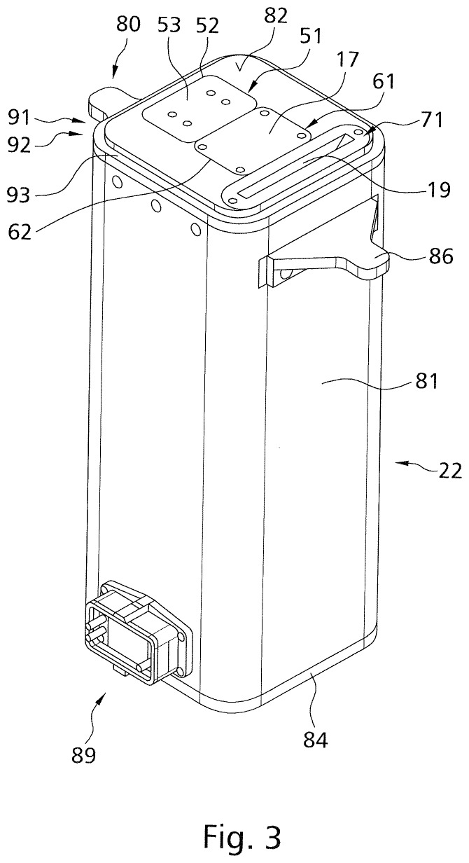

FIG. 3 a perspective view of an interchangeable container for tree reduction,

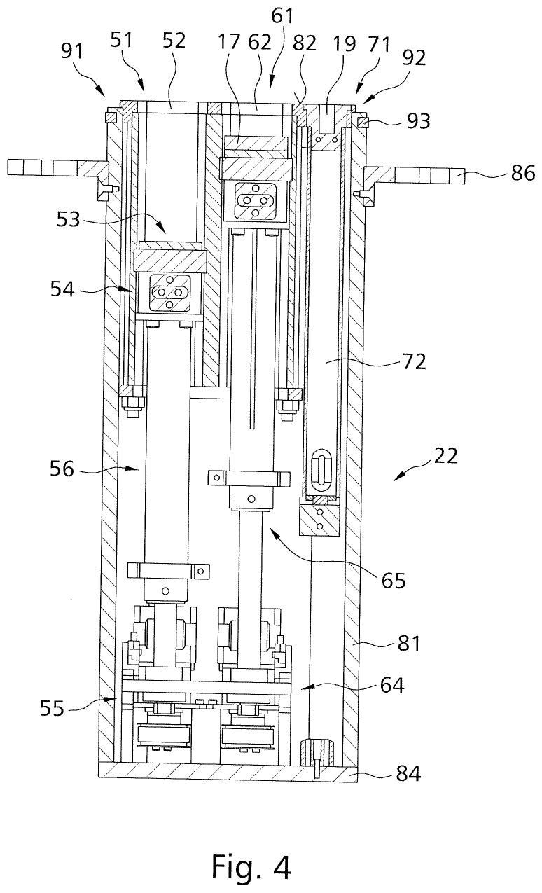

FIG. 4 a schematic sectional view of the interchangeable container shown in FIG. 3,

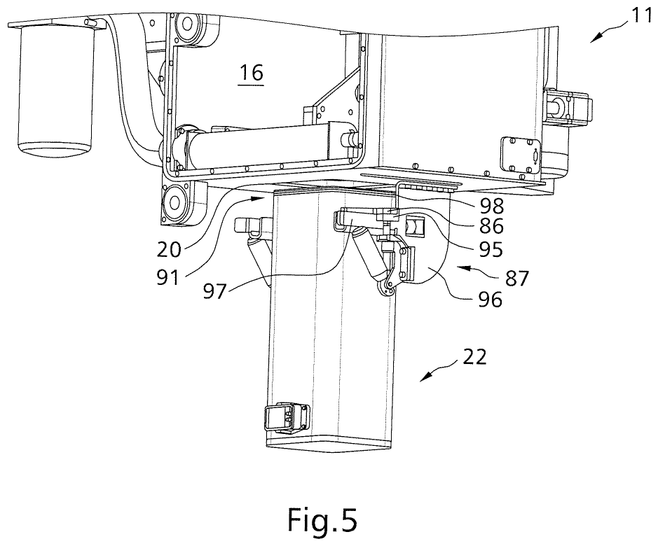

FIG. 5 a perspective view of a first step in attaching the interchangeable container to the process chamber,

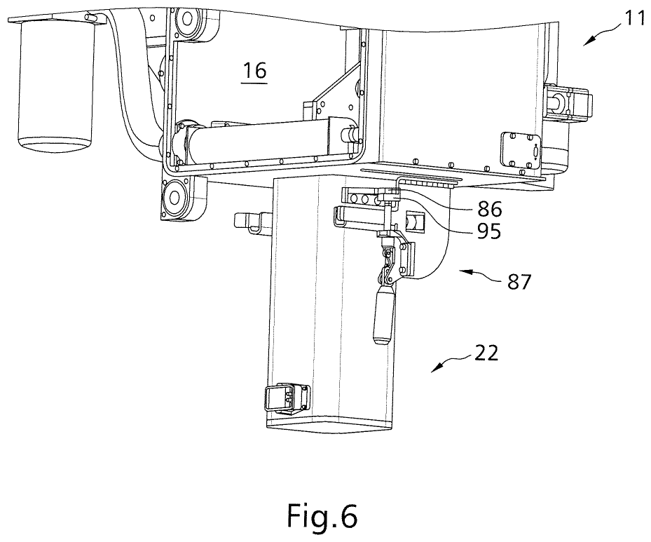

FIG. 6 a perspective view of the exchangeable container attached to the process chamber,

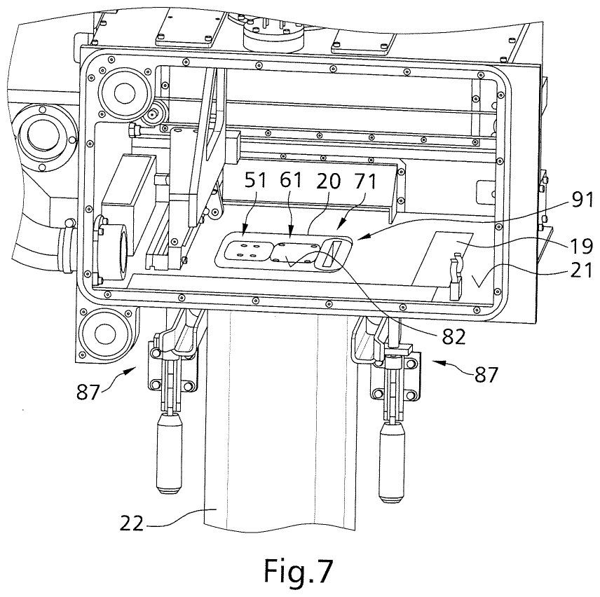

FIG. 7 a perspective view of the process chamber with the interchangeable container as shown in FIG. 3,

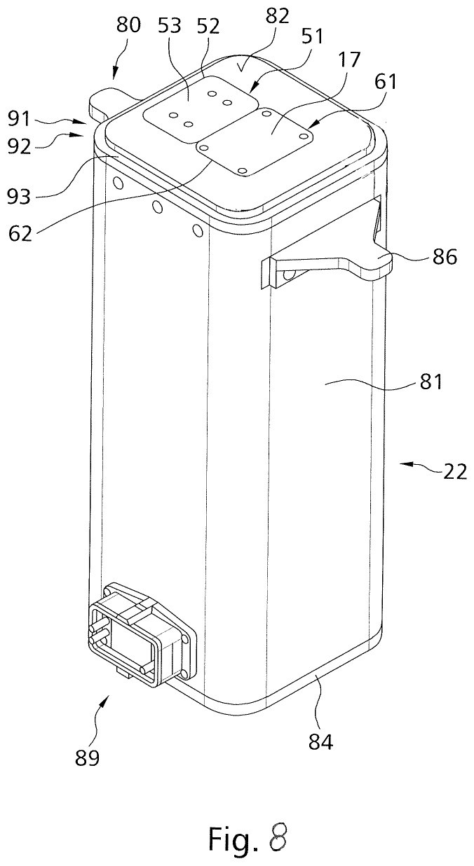

FIG. 8 a perspective view of an alternative embodiment of the interchangeable container to FIG. 3, and

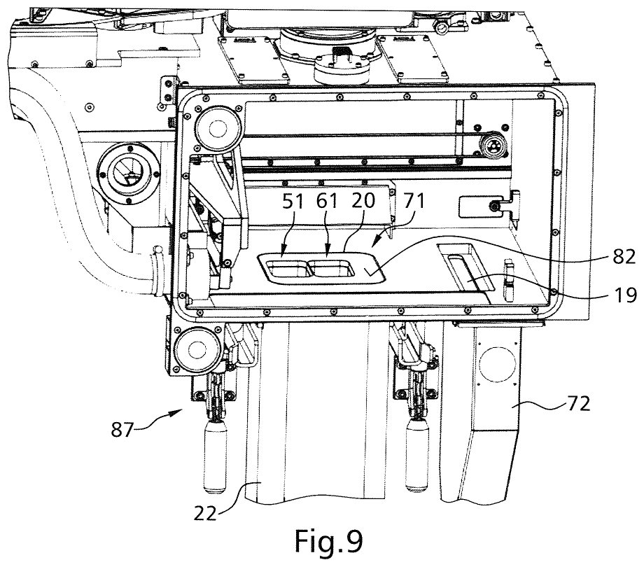

FIG. 9 a perspective view of the process chamber with the interchangeable container as shown in FIG. 8.

FIG. 1 shows a perspective view of a device 11 for producing three-dimensional components 12 by selectively solidifying a build-up material applied in layers. A process chamber 16 of this device 11 is shown in detail, and the other components are shown schematically. FIG. 2 shows a top view of the process chamber 16. These devices 11 are also referred to as 3-D printing systems, selective laser sintering machines, selective laser melting machines or the like. This device 11 comprises a housing 14 in which the process chamber 16 is provided. This process chamber 16 is closed to the outside and is accessible, for example, via a door 24, which preferably comprises a safety lock and a handle. This door 24 is provided on a front side 23 of the housing 14 and closes an opening 28 in the process chamber 16. A seal 29 is provided around the outside of the opening 28 in order to hermetically seal the process chamber 16. The seal 29 can be provided on the door 24 or the front 23 of the housing 14.

A floor 21 is aligned in an X-Y plane in the process chamber 16. A build-up platform 17, on which the three-dimensional component 12 is produced layer by layer, can be moved opposite this floor 21. This build platform 17 can be moved in the Z direction relative to the work surface formed by the floor 21 of the process chamber 16. The build-up platform 17 is preferably provided in an interchangeable container 22. Adjacent to the build-up platform 17, for example, an overflow container or an overflow slot 19 is provided with a preferably removable container positioned below it, in which unneeded or unconsolidated build-up material 13 is collected. Furthermore, a storage container can be provided, through which fresh build-up material 13 is provided. This build-up material 13 can also be fed to the build-up platform 17 by an application and leveling device 30 on the one hand and, on the other hand, unneeded or superfluous build-up material 13 can be transferred to the overflow container 19. This application and leveling device 30 can also have a metering device for supplying body material 13. In this case, the storage container can be omitted. This application and leveling device 30 is moved along a work surface with a drive unit not shown in detail.

The build-up material 13 preferably consists of a metal or ceramic powder. Other materials suitable for laser melting or laser sintering can also be used.

A beam source 15, such as a laser source, is provided above the mounting platform 17 on the housing 14 or adjacent thereto. The beam source 15 emits a beam 25, which is deflected onto the working surface, in particular the mounting platform 17, via a beam deflection device 18. The beam deflection device 18 can take the form of one or more controllable mirrors, in particular in the form of a scanner. In addition, the beam deflection device 18 can also comprise optical elements for focusing the beam 25.

The process chamber 16 is hermetically sealed. This is filled with a protective gas, in particular an inert gas, for the production of the three-dimensional component 12, for example to prevent oxidation during the melting of the build-up material 13.

A shielding gas circulation system 31 is provided for supplying a shielding gas and for discharging the process gas, which corresponds to the contaminated shielding gas. This protective gas circulation system 31 comprises a filter device 36 and a vacuum generation device 37 for generating a gas flow. Starting from the filter device 36, shielding gas is supplied via a conveying line 38 to at least one inlet opening 39, which is arranged in a wall of the process chamber 16. This inlet opening 39 can be provided in a rear wall 59. Alternatively, the inlet opening 39 can also be provided on one or both side walls and/or on the rear wall.

To extract the supplied process gas, an extraction device 41 is provided, which is associated with the opening 28. This suction device 41 comprises a suction pipe 42. The suction pipe 42 comprises a suction opening 43, which is preferably slot-shaped and is aligned with the mounting platform 17. The process gas sucked in via the suction pipe 42 is led out of the process chamber 16 and fed to the filter device 36 via a suction line 46.

The shielding gas circulation system 31 generates a stream of shielding gas in accordance with the arrows 35, which passes through the process chamber 16 above the working surface. In this way, a protective gas envelope can be achieved for the build-up material 13 during the selective solidification of the build-up material 13 by the beam 25. In addition, any soot, smoke or other impurities or dirt particles produced can be sucked in and removed by this protective gas flow 35 via the suction opening 43 of the suction tube 42.

The protective gas flow 35 generated by the protective gas circulation system 31 as described above is referred to as the primary flow. In addition, a secondary flow can also be generated by the shielding gas circulation system 31. For this purpose, further inlet openings are preferably provided in a ceiling of the process chamber 16 or in side walls and/or the rear wall of the process chamber 16.

The interchangeable container 22 shown in FIG. 1 is preferably arranged so that it can be exchanged for the opening 20 in the base 21. To reduce the volume of installation space, an interchangeable container 22 as shown in FIG. 3 is preferred. Integrated in this interchangeable container 22 is a storage device 51 for receiving the powdery build-up material 13 and a construction chamber 61 for receiving the build-up platform 17 as well as a collecting device 71 for receiving unconsolidated build-up material. This interchangeable container 22 comprises a closed peripheral wall 81. A working surface 82 is provided at the upper end of the peripheral wall 81, which closes the peripheral wall 81. An opening 52 for the storage device 51, an opening 62 for the construction chamber 61 and an overflow slot 19 of the collecting device 71 are provided in the working surface 82. Preferably, the length of the overflow slot 19 is greater than the length of the openings 52 and 62. The interchangeable container 22 has a base 84, in particular a closed base, on its underside.

Thus, the interchangeable container 22 can be formed as a closed unit by the peripheral wall 81, the closed base 84 and the working surface 82 arranged opposite at the upper end. At least one fastening element 86 is provided on the outside of the interchangeable container 22. This fastening element 86 is part of a fastening device 87 (FIG. 5), which is preferably provided on the process chamber 16 in order to fix the interchangeable container 22 interchangeably to the process chamber 16.

The interchangeable container 22 has at least one plug-in connection 89. The plug-in connection 89 comprises at least connection elements for the electrical power supply.

FIG. 4 shows a schematic sectional view of the interchangeable container 22 as shown in FIG. 3. The storage device 51 comprises a piston 53 which can be moved up and down relative to the opening 52. This piston 53 is preferably guided in a chamber wall 54 so that it can be moved up and down. A piston drive 55 is provided to control the movement of the piston 53. This may be an electric motor or the like. A spindle drive 56 is provided between the piston drive 55 and the piston 53. This allows the height of the interchangeable container to be reduced.

Adjacent to the storage device 51 and separate from it is the construction chamber 61 with the construction platform 17 that can be moved up and down in it. The up and down movement of the superstructure platform 17 is performed by a construction chamber drive 64, which in turn drives a spindle drive 65. This spindle drive 65 also serves to reduce the overall height of the swap body.

The piston actuator 55 and the actuator 64 are separate actuators. These are controlled independently of each other. The piston drive 55 and the construction chamber drive 64 are preferably mechanically decoupled from each other.

Furthermore, the collecting device 71 is provided in the interchangeable container 22. A collecting container 72 for unconsolidated superstructure material 13 is provided below the overflow slot 19.

The construction chamber 61 is arranged between the storage device 51 and the collecting device 71. The square or rectangular geometry of the piston 53 or the mounting platform 17 are only examples.

A connection interface 91 is provided at the upper end of the exchangeable cylinder 22. This connection interface 91 is designed as a stepped shoulder 92. After fixing the interchangeable container 22 in the opening 20 of the base 21, a working surface of the base 21 is advantageously aligned flush with the working surface 82 of the interchangeable container 22. Furthermore, a circumferential sealing element 93 is provided in the connection interface 91.

The replacement of an interchangeable container 22 to the process chamber 16 is described below with reference to FIGS. 5 and 6. The fastening device 87 is advantageously designed as a tool-free clamping device. In the embodiment example, it is a clamping lever or toggle lever. The fastening device 87 is provided on a retaining element 96. This holding element 96 is preferably fixed to an underside of the process chamber 16. This retaining element 96 has a web-shaped support section 97. In a first fastening step, the interchangeable container 22 is placed on the support section 97 below the base 21 and moved into a position so that the fastening element 86 of the interchangeable container 22 is aligned with the fastening element 95. At the same time, the interchangeable container 22 can be positioned against the stop so that the three-dimension interface 91 is aligned with the opening 20 in the base 21. The clamping levers of the fastening device 87 are then actuated and the interchangeable container 22 is inserted from below into the opening 20 of the base 21 and fixed in place. At the same time, the opening 20 in the base 21 is sealed by the sealing element 83. The fixed arrangement of the interchangeable container 22 or the arrangement of the fastening device 87 in a clamping position is shown in FIG. 6.

The interchangeable container 22 according to FIG. 6, which is fixed to the base 21 of the process chamber 16, is shown in a perspective view from above in FIG. 7. The working surface 82 of the interchangeable container 22 is preferably flush with the working surface of the base 21 of the process chamber 16. The application and levelling device 30 exclusively distributes and levels the build-up material 13 in the construction chamber 61, which is dispensed by the supply device 51. This fresh build-up material 13 is transferred to the construction chamber 61. Excess build-up material 13 is transferred to the collecting device 71 via the overflow slot 19. The working space within the process chamber 16 is thus located within the opening 20 of the base 21. This results in a significant reduction in installation space compared to the embodiment in FIG. 2. It is understood that when the interchangeable container 22 is positioned in relation to the process chamber 16 as shown in FIG. 3, as shown in FIG. 7, the application and levelling device 30 is only controlled with regard to the levelling function.

FIG. 8 shows a perspective view of an alternative embodiment of the interchangeable container 22 to FIG. 3. This interchangeable container 22 according to FIG. 8 corresponds in its entirety to the embodiment of the interchangeable container 22 according to FIG. 3, with the exception that the interchangeable container 22 according to FIG. 8 comprises exclusively a storage device 51 and a construction chamber 61. A collecting device 71 is not provided in the interchangeable container 22.

With regard to the design of the interchangeable container 22, reference can be made to the above description of FIGS. 3 to 7. A sectional view of the interchangeable container 22 according to FIG. 8 corresponds to the representation in FIG. 4, with the exception that a closed working surface 82 is provided instead of the overflow slot 19. A collecting container 72 is also not provided.

The embodiment of the interchangeable container 22 according to FIG. 3 can also be converted into an embodiment according to FIG. 8, in which a media-tight closure is inserted into the overflow slot 19, with an upper side of the closure closing flush with the working surface 82.

FIG. 9 shows a perspective view of the process chamber 16 with the interchangeable container 22 as shown in FIG. 8. The positioning of the interchangeable container 22 in relation to the connection interface 91 in the process chamber 16 and the detachment from the connection interface 91 are carried out as described in FIGS. 5 to 7 above. In this embodiment according to FIG. 9, it is provided that the overflow slot 19 in the base 21 of the process chamber 16 is open, so that excess build-up material 13 or unconsolidated build-up material 13 can be fed by the application and leveling device 30 via the overflow slot 19 to the collecting device 71 positioned below. This embodiment of the exchangeable container 22 exclusively with the storage device 51 and the construction chamber 61 has the advantage that it can be designed in a simplified manner compared to the embodiment in FIGS. 3 and 4.

1. Interchangeable container for a process chamber of a device for producing a three-dimensional component by selective solidification of a build-up material applied in layers by means of a beam acting on the build-up material,
with a peripheral wall and a connection interface formed on the upper edge of the peripheral wall for connection to a base of the process chamber,
characterized in that the interchangeable container comprises inside the peripheral wall:
a storage device with a piston for dispensing powdered build-up material, which is actuatable by a piston drive,
a building chamber with a build platform for building up the component in layers, which is drivable by a building chamber drive, and
a working surface provided at the upper end of the peripheral wall, which has an opening each for the storage device, the construction chamber and the collecting device.

2. Interchangeable container according to claim 1, characterized in that the storage device and the construction chamber are positioned adjacent or adjoining one another a collecting device is provided opposite the storage device and adjacent to or adjoining the construction chamber for receiving unsolidified construction material.

3. Interchangeable container according to claim 1, characterized in that a base or a closed base, is provided at the lower end of the peripheral wall.

4. Interchangeable container according to claim 1, characterized in that at least one fastening element is provided on an outer circumference of the circumferential wall, which fastening element is interchangeably fixed to the process chamber with a further fastening element of a fastening device.

5. Interchangeable container according to claim 1, characterized in that the connection interface is designed as a stepped shoulder with a circumferential sealing element.

6. Interchangeable container according to claim 1, characterized in that the connection interface is connectable from below to the opening of the base of the process chamber.

7. Interchangeable container according to claim 1, characterized in that a plug-in connection is provided in the peripheral wall at least for the electrical supply of the piston drive and/or the construction chamber drive.

8. Interchangeable container according to claim 1, characterized in that the piston drive and the construction chamber drive is actuatable separately from one another.

9. Interchangeable container according to claim 1, characterized in that a respective spindle drive is provided between the piston drive and the piston and between the construction chamber drive and the mounting platform.

10. Interchangeable container according to claim 1, characterized in that the length of the overflow slot of the collecting device is greater than the length of the opening of the storage device and the opening of the construction chamber.

11. Interchangeable container according to claim 1, characterized in that the peripheral wall has a square or rectangular cross-section.

12. Apparatus for producing a three-dimensional component by selective solidification a build-up material applied in layers by means of a beam acting on the build-up material
with a process chamber which comprises a base which has a working surface aligned in the X/Y plane,
with an interchangeable container which is positionable in an opening in the working surface of the base,
with a leveling device, which is movable along the working surface of the floor and feeds powdered build-up material to a build-up platform in the interchangeable container,
with a protective gas circulation system, which supplies a process gas to the process chamber and extracts contaminated process gas from the process chamber,
characterized in that
in that the interchangeable container is provided according to claim 1, and
that the interchangeable container is positionable in the opening of the base of the process chamber to reduce the installation space.

13. Device according to claim 12, characterized in that a fastening element of the fastening device is provided in association with the process chamber, which fastening element is connectable to the fastening element on the interchangeable container and detachably fixes the interchangeable container in a working position relative to the base of the process chamber).

14. Device according to claim 12, characterized in that the fastening device is designed as a quick-clamping device.

15. Device according to claim 13, characterized in that the fastening device is actuatable without tools.

16. Device according to claim 12, characterized in that the interchangeable container is positionable in a first fastening step by the fastening element arranged thereon, hanging loosely relative to the fastening element arranged on the process chamber and aligned with the opening of the base, and in a second fastening step the connection interface of the interchangeable container is braceable with the opening of the base.

17. Interchangeable container according to claim 11, wherein the peripheral wall has a square or rectangular cross-section with rounded corner regions.

18. Device according to claim 14, wherein the fastening device is fastened to the process chamber.
